(19) United States
(12) Patent Application Publication
(10) Pub. No.: US 2015/0043612 A1
(43) Pub. Date: Feb. 12, 2015

(54) METHOD FOR HEAT QUANTITY MEASUREMENT WITH AN ULTRASONIC, FLOW MEASURING DEVICE

(71) Applicant: Endress + Hauser Flowtec AG, Reinach (CH)

(72) Inventors: Achim Wiest, Weil am Rhein (DE); Oliver Brumberg, Rheinfelden (DE); Andreas Berger, Hasel-Glashutten (DE)

(21) Appl. No.: 14/359,650

(22) PCT Filed: Oct. 24, 2012
(86) PCT No.: PCT/EP2012/070998

§ 371 Date: May 21, 2014

(30) Foreign Application Priority Data
Nov. 28, 2011 (DE) 10 2011 087 215.9

(51) Int. Cl. G01K 13/02; G01L 13/00; G01K 7/16; G01F 1/66; G01K 11/24

(52) U.S. Cl. CPC G01K 13/02; G01F 1/662; G01K 11/24; G01K 7/16; G01L 13/00
USPC 374/119

(57) ABSTRACT

A method and apparatus for heat quantity measurement, wherein, with an ultrasonic, flow measuring device, which works according to the travel time difference principle, the flow of a fluid of known chemical composition through the lumen of a pipeline is ascertained, and wherein the temperature of the fluid before and after a heat transferer is ascertained, wherein, for a first ascertaining of the temperature of the fluid, the velocity of sound in the fluid is ascertained with the ultrasonic, flow measuring device and a temperature is ascertained outside of the lumen of the pipeline.

The present invention relates to a method and an apparatus for heat quantity measurement, wherein, with an ultrasonic, flow measuring device, which works according to the travel time difference principle, the flow of a fluid of known chemical composition through the lumen of a pipeline is ascertained, and wherein temperature of the fluid downstream and upstream of a heat transferer is ascertained.

An ultrasonic, flow measuring device and temperature sensors before and after a heat transferer are conventionally used for heat quantity measurement. The ultrasonic, flow measuring device ascertains the flow of a measured medium, most often, a fluid, through a pipeline and the temperature sensors the values of temperature of the fluid before and after the heat transferer. Using the volume flow or mass flow and the temperature difference, the heat, or energy, amount transferred by the heat transferer is ascertained.

Ultrasonic, flow measuring devices are applied often in process- and automation technology. They permit simple determination of volume flow and/or mass flow in a pipeline.

Known ultrasonic, flow measuring devices work frequently according to the travel-time difference principle. According to the travel-time difference principle, the different travel times of ultrasonic waves, especially ultrasonic pulses, so-called bursts, are evaluated relative to the flow direction of the liquid. For this, ultrasonic pulses are sent at a certain angle to the tube axis both with, as well as also counter to, the flow. From the travel-time difference, the flow velocity, and therewith, in the case of known diameter of the pipeline section, the volume flow rate can be determined.

The ultrasonic waves are produced, respectively received, with the assistance of so-called ultrasonic transducers. For this, the ultrasonic transducers are mounted in the tube wall of the relevant pipeline section. Also clamp on, ultrasonic, flow measuring systems exist, wherein, in such case, the ultrasonic transducers are pressed externally against the wall of the measuring tube. A great advantage of clamp-on, ultrasonic, flow measuring systems is that they do not contact the measured medium and can be mounted directly on a pipeline.

The ultrasonic transducers are, normally, composed of an electromechanical transducer element, e.g. a piezoelectric element, and a coupling layer. The ultrasonic waves are produced as acoustic signals in the electromechanical transducer element and, in the case of clamp-on systems, led via the coupling layer to the tube wall and from there into the liquid, or, in the case of inline systems, via the coupling layer into the measured medium. In such case, the coupling layer can also be referred to as a membrane, or diaphragm.

Arranged between the piezoelectric element and the coupling layer can be another coupling layer, a so called adapting, or matching, layer. The adapting, or matching, layer, in such case, performs the function of transferring the ultrasonic signal and simultaneously reducing reflection caused by different acoustic impedances at interfaces between two materials.

Also, the measuring of the temperature of the measured medium by means of ultrasonic, flow measuring devices is known to those skilled in the art.

An object of the invention is to provide a method for heat quantity measurement, which is simple and cost effective to perform.

The object is achieved by the subject matter of independent claim 1. Further developments and embodiments of the invention are reflected in the features of the dependent claims.

The invention permits numerous forms of embodiment. Some thereof will now be explained in greater detail based on the figures of the drawing. Equal elements are provided in the figures with equal reference characters. The figures of the drawing show as follows:

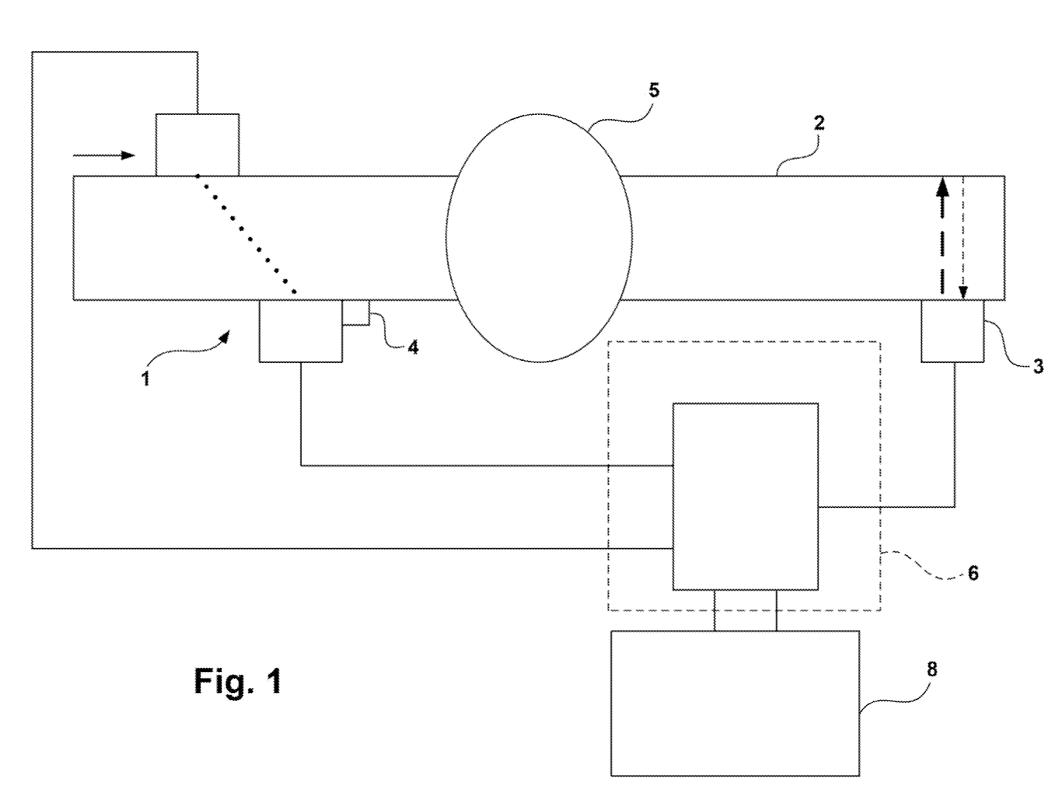

FIG. 1 an apparatus of the invention for heat quantity measurement in a first embodiment,

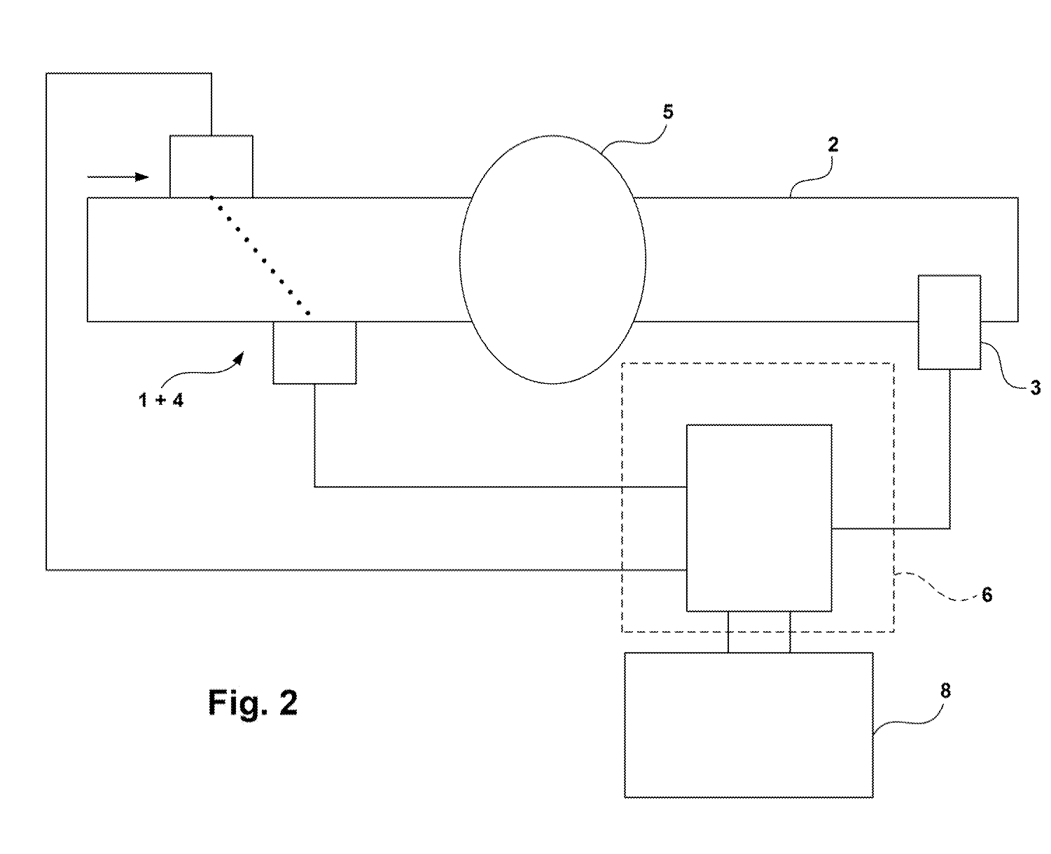

FIG. 2 an apparatus of the invention for heat quantity measurement in a second embodiment,

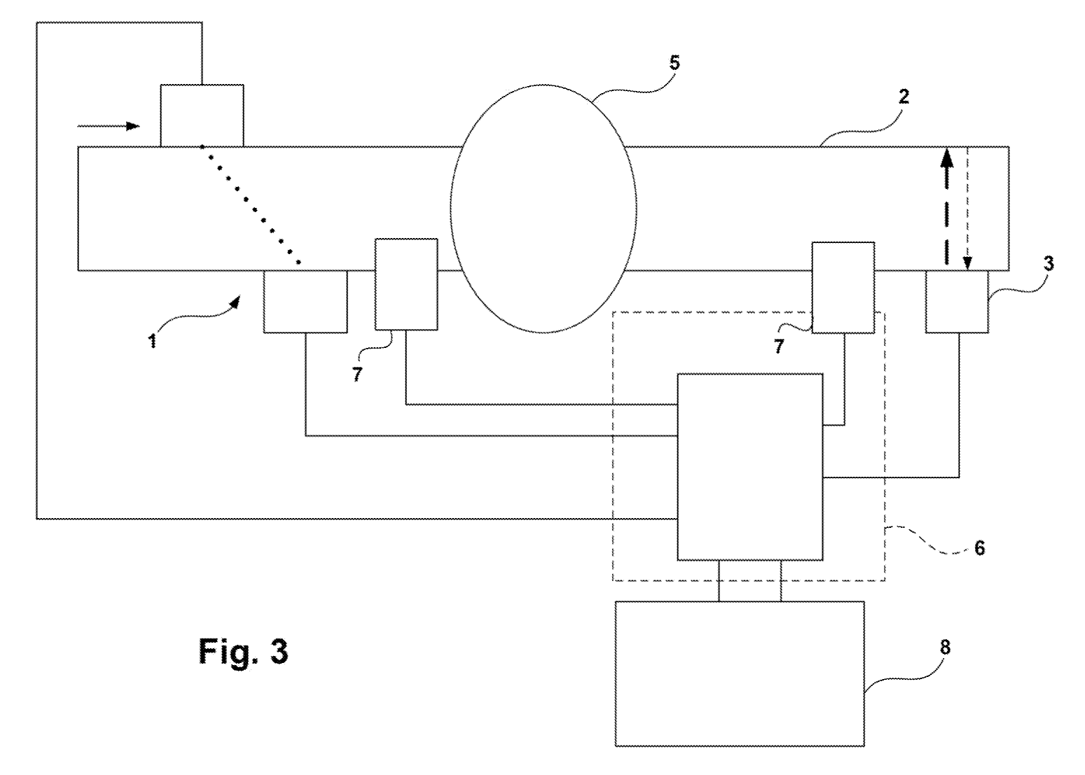

FIG. 3 an apparatus of the invention for heat quantity measurement in a third embodiment,

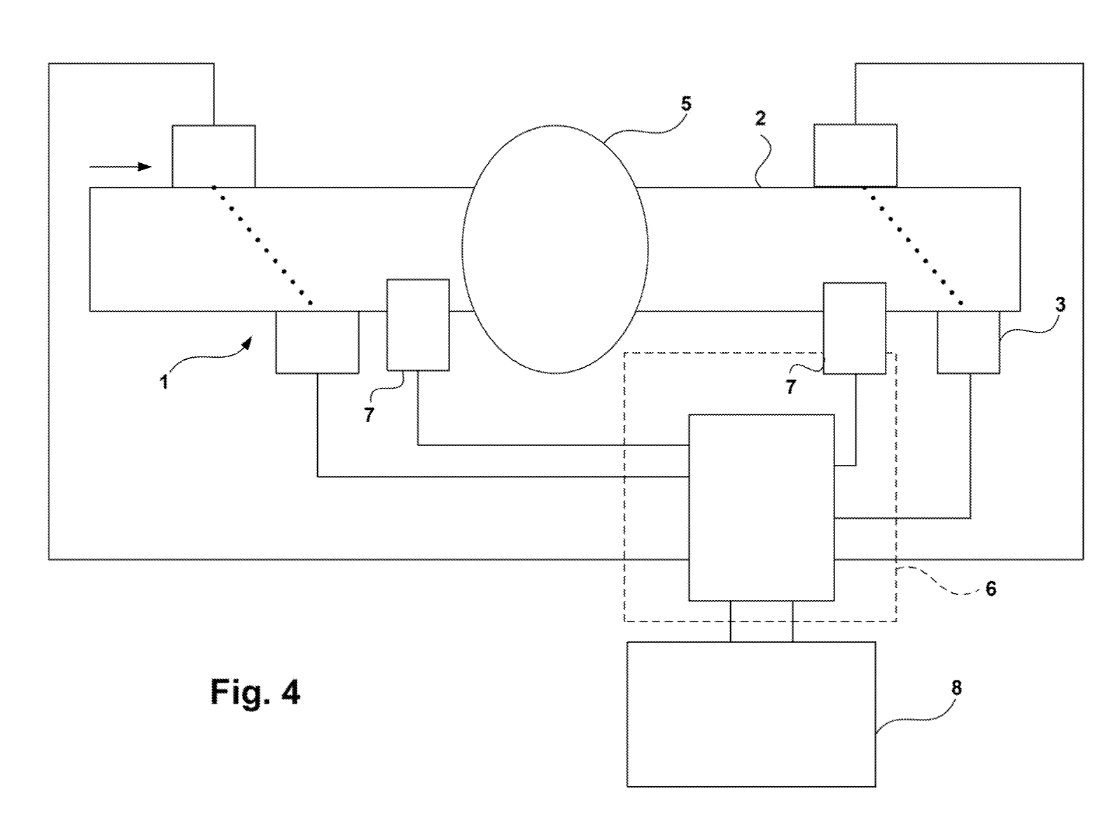

FIG. 4 an apparatus of the invention for heat quantity measurement in a fourth embodiment,

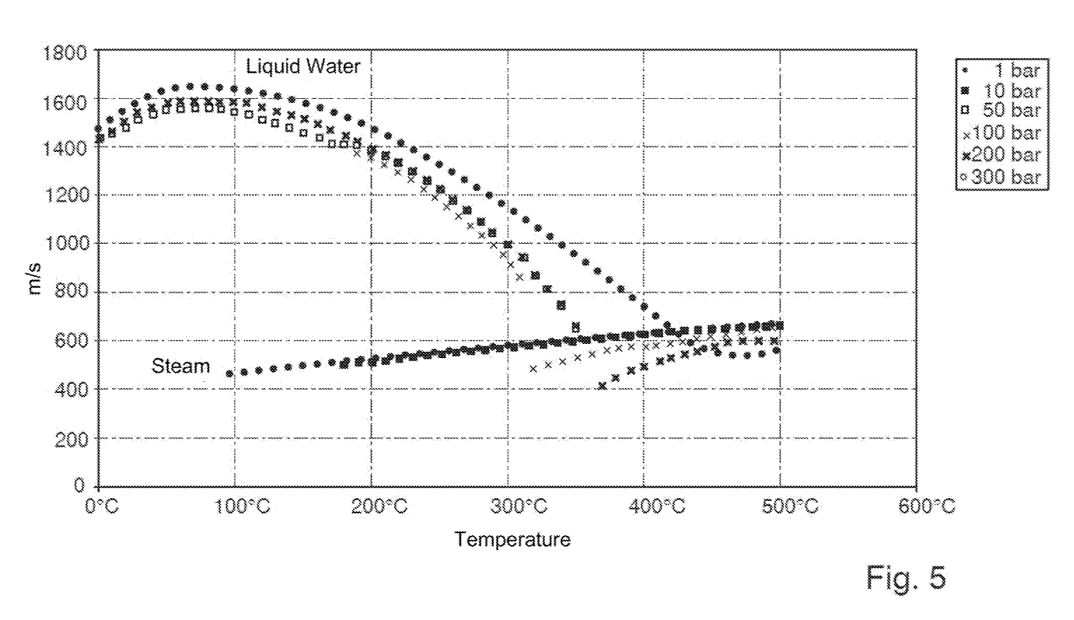

FIG. 5 a graph of velocity of sound in water as a function of temperature.

FIG. 1 shows an apparatus of the invention for heat quantity measurement in a first embodiment. The apparatus includes an ultrasonic, flow measuring device 1, which works especially according to the travel time difference principle, for ascertaining the flow of a fluid through a pipeline 2. The ultrasonic, flow measuring device 1 is arranged in the flow direction of the fluid at a first position on a first side of a heat transferer 5 on or in the pipeline 2. The fluid is, for example, a gas or a liquid.

The ultrasonic, flow measuring device 1 is further developed as a clamp-on, ultrasonic, flow measuring device, which is arranged on the surface of the pipeline 2.

Furthermore, the apparatus of the invention includes a first temperature sensor 3 for ascertaining a value of the temperature of the fluid in the pipeline. Temperature sensor 3 is arranged at a second position on the other, second side of the heat transferer 5. If the ultrasonic, flow measuring device 1 is located upstream of the heat transferer 5, then the first temperature sensor 3 is arranged downstream of the heat transferer 5 on or in the pipeline 2. If, conversely, the ultrasonic, flow measuring device 1 is arranged downstream of the heat transferer 5 on or in the pipeline 2, then the first temperature sensor 3 is located upstream of the heat transferer 5.

The ultrasonic, flow measuring device 1 is, in such case, according to the invention, suitably embodied for ascertaining the velocity of sound of the fluid in the pipeline 2. Furthermore, the apparatus includes a means, especially an additional, second temperature sensor 4, which is suitable for ascertaining a value of the temperature outside of the lumen of the pipeline 2 at the first position on the first side of the heat transferer S.

A heat transferer 5 can, in such case, be both a heat sink as well as also a heat source. For example, heat from a heating plant, for example, a gas or oil burner or an electrical heater, is transferred to the fluid, or, however, heat is withdrawn from the fluid via the heat transferer, for example, in the case of a radiator of the heating plant or in an air conditioning plant. Other examples of heat transferers are heat exchangers in the process industry or heat engines or heat pumps.

The apparatus of the invention is applied for performing the subsequently described method of the invention. For heat quantity measurement, the ultrasonic, flow measuring device 1 ascertains the flow of the fluid of known chemical composition through the lumen of the pipeline 2. Moreover, values of the temperature of the fluid upstream and downstream of the heat transferer 5, thus before and after the heat transferer, are ascertained. This happens according to the invention by features including that, at a first ascertaining of a first value of the temperature of the fluid at the first position on the first side of the heat transferer, the velocity of sound of the fluid is ascertained with the ultrasonic, flow measuring device, and a second value of the temperature is ascertained outside of the lumen of the pipeline 2.

The first value of the temperature outside of the lumen of the pipeline is ascertained, for example, with a second temperature sensor 4, especially a resistance thermometer, arranged on the pipeline surface, or, for example, in a coupling element of an ultrasonic transducer of the ultrasonic, flow measuring device by travel-time measurement. This principle is known to those skilled in the art, for instance from DE 10 2007 062 913 A1, to which reference is made herewith. Known are the material of the coupling element and the distance at a predetermined temperature, which a predetermined ultrasonic signal travels to a predetermined reflection surface and back to the ultrasonic transducer element, as well as the velocity of sound in the coupling element as a function of temperature and as a function of the distance between ultrasonic transducer element and reflection surface. From the travel time of the ultrasonic signal from the ultrasonic transducer element to the reflection surface and back, the temperature of the coupling element can be easily ascertained.

The second value of the temperature at the second position on the second side of the heat transferor is ascertained, for example, with an ultrasonic transducer as ultrasonic temperature sensor, which ascertains the velocity of sound in the fluid and, in given cases, a third value of the temperature outside of the pipeline according to, for example, the above recounted ways, or there serves for ascertaining the second value of the temperature at the second position on the second side of the heat transferor a temperature sensor contacting the fluid, especially a temperature sensor in the form of a resistance thermometer, such as illustrated in FIG. 2. The apparatus of the invention is, in each case, correspondingly embodied, thus includes the corresponding temperature sensor. FIG. 2 differs from FIG. 1 only in the manner of ascertaining the value of the temperature at the second position.

For ascertaining a value of the temperature by means of the velocity of sound in a material, here especially in the fluid, for example, a known dependence of the velocity of sound on the temperature of the material, here of the fluid, is taken into consideration. If the velocity of sound in the fluid is supplementally dependent on the pressure in the fluid, according to a form of embodiment of the invention, the pressure in the fluid is supplementally ascertained and taken into consideration for ascertaining the temperature of the fluid. FIG. 5 shows the dependence of the velocity of sound in water on the temperature of the water in the case of different pressures.

The invention requires a sensitive and therewith comparatively expensive temperature sensor less than the state of the art, since the second temperature sensor can be cost effectively embodied. A further advantage of the invention is that the value of the flow can be corrected by means of the value of the temperature of the second temperature sensor and therewith accuracy of the flow determination is increased. A further advantage of determining the temperature of the fluid by means of ultrasound is the integral determining of the temperature over the total sound path and not only at the point of a temperature sensor. Thus, inhomogeneous temperature distributions in the medium can be taken into consideration better.

The apparatus of the invention includes, for example, a measurement transmitter 6, in which for the known fluid curves for the velocity of sound as a function of temperature and, in given cases, pressure and/or additional physical, especially thermodynamic, variables, such as, for example, the aggregate state, are furnished and which measurement transmitter 6 is suited to ascertain therefrom the value of the temperature of the fluid at the corresponding position, here especially the first position, in the flow direction of the fluid through the pipeline before and/or after the heat transferer.

FIG. 3 shows another embodiment of the invention. In this further development of the invention, the apparatus of the invention includes at least one pressure transducer 7, in order to measure the pressure, especially the absolute pressure, in the fluid.

In the shown variant of the invention, the apparatus of the invention includes two pressure transducers 7, or a pressure difference transducer, for ascertaining the pressure difference of the fluid before and after the heat transferer 5, thus between the first and the second positions.

As already described, signals representing the values of the travel times, respectively the travel-time difference of the ultrasonic signals transmitted and received by the ultrasonic flow device, the temperatures at the first and second positions and, in given cases, the pressure or even the pressure difference, are fed to the measurement transmitter, which computes therefrom the value of the temperature at the first and second positions and the volume flow or mass flow of the fluid through the pipeline and forwards such to a heat quantity calculator 8, which then computes the heat, or energy, amount used by the heat transferer. The heat quantity calculator can, in such case, be a component of the measurement transmitter.

This embodiment of the invention is especially advantageous for heat quantity measurement of gases, by a simple measuring of the energy of the gas before and after the heat transferer by means of the pressure transducer.

Advantageous is furthermore an additional, second flow measuring device on the second side of the heat transferer, such as shown in FIG. 4, in order to achieve a higher accuracy of the measurements, e.g. in the case of long-distance heating with steam or especially in the case of aggregate state changes of the fluid downstream from the first flow measuring device. Therefore, according to an embodiment of the invention, the temperature sensor is a flow measuring device, which is suited to determine the temperature of the fluid. For example, the temperature sensor is a flow measuring device in the form of an ultrasonic, flow measuring device, a thermal, flow measuring device or a Coriolis, flow measuring device.

### LIST OF REFERENCE CHARACTERS

1 ultrasonic, flow measuring device
2 pipeline
3 first temperature sensor
4 second temperature sensor
5 heat transferer
6 measurement transmitter
7 pressure transducer
8 heat quantity calculator

1-10. (canceled)

11. A method for heat quantity measurement, wherein, with an ultrasonic, flow measuring device, which works according to the travel time difference principle, comprising the steps of:
ascertaining the flow of a fluid of known chemical composition through the lumen of a pipeline; and
ascertaining the temperature of the fluid before and after a heat transferer is ascertained, wherein:
for a first ascertaining of the temperature of the fluid, the velocity of sound in the fluid is ascertained with the ultrasonic, flow measuring device and a temperature outside of the lumen of the pipeline is ascertained.

12. The method as claimed in claim 11, wherein:
the ultrasonic, flow measuring device is a clamp-on, ultrasonic, flow measuring device, which is arranged on the surface of the pipeline.

13. The method as claimed in claim 11, wherein:
the temperature outside of the lumen of the pipeline is ascertained by means of a temperature sensor, especially a resistance thermometer, arranged on the measuring tube surface.

14. The method as claimed in claim 11, wherein:
the temperature outside of the lumen of the pipeline is ascertained by means of a travel-time measurement in a coupling element of an ultrasonic transducer of the ultrasonic, flow measuring device.

15. The method as claimed in claim 11, wherein:
for a second ascertaining of the temperature of the fluid, the velocity of sound in the fluid is ascertained with an ultrasonic temperature sensor.

16. The method as claimed in claim 11, wherein:
for a second ascertaining of the temperature of the fluid, the temperature of the fluid is ascertained with a temperature sensor, especially a resistance thermometer, contacting the fluid.

17. The method as claimed in claim 11, wherein:
the pressure in the fluid is measured.

18. The method as claimed in claim 17, wherein:
the difference between a first pressure in the fluid before, and a second pressure in the fluid after, the heat transferer is ascertained.

19. The method as claimed in claim 11, wherein:
for ascertaining the temperature of the known fluid, a known dependence of the velocity of sound on the temperature is taken into consideration.

20. An apparatus for heat quantity measurement, comprising:
an ultrasonic, flow measuring device for ascertaining the flow of a fluid through a pipeline, which ultrasonic, flow measuring device is arranged in the flow direction of the fluid on a first side of a heat transferer; and
a temperature sensor arranged on another, second side of said heat transferer; wherein:
said ultrasonic, flow measuring device is suitably embodied for ascertaining the velocity of sound in the fluid;
a means suited for ascertaining a temperature outside of the lumen of the pipeline on the first side of said heat transferer.
